(19) United States
(12) Patent Application Publication
(10) Pub. No.: US 2017/0277265 A1
(43) Pub. Date: Sep. 28, 2017

(54) SINGLE AXIS GESTURE RECOGNITION

(71) Applicant: SYNAPTICS INCORPORATED, San Joe, CA (US)

(72) Inventors: Chia-Yun KUAN, Sunnyvale, CA (US); Sanjay MANI, Los Altos Hills, CA (US)

(21) Appl. No.: 15/080,135

(22) Filed: Mar. 24, 2016

(51) Int. Cl. G06F 3/01; G06F 3/041; G06F 3/044

(52) U.S. Cl. CPC G06F 3/017; G06F 3/044; G06F 3/0416; G06F 2203/04101; G06F 2203/04102; G06F 2203/04105

(57) ABSTRACT

Embodiments herein describe an input device that includes a sensing region that permits the device to identify a location of an input object (e.g., a finger) along a side of the device. For example, the sensing region may include sensor electrodes that form a stack with display elements used to display images to the user. By performing capacitive sensing with the sensor electrodes, the input device can identify the location of input objects that are proximate to the side of the sensing region. In one embodiment, the input device includes a finger index for tracking information about input objects disposed at the side of the input device. By tracking the movement of the input objects using the finger index, the input device can determine if the user is performing a tapping or swiping gesture along the side of the input device.

### FIELD OF THE INVENTION

This invention generally relates to electronic devices and using capacitive sensing to identify gestures along a single axis.

### BACKGROUND OF THE INVENTION

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

### BRIEF SUMMARY OF THE INVENTION

One embodiment described herein is an input device that includes a plurality of sensor electrodes in a sensing region of the input device and a processing system coupled to the plurality of sensor electrodes. The processing system is configured to evaluate capacitive sensing data to identify a current location of an input object along a single axis and identify, using the current location, an entry in a data structure corresponding to the input object, wherein the data structure is configured to store multiple entries each corresponding to a different input object previously detected by the processing system. The processing system is configured determine whether the input object has performed a predefined gesture by comparing the current location to a previous location of the input object on the single axis, wherein the previous location was stored in the identified entry.

Another embodiment described herein is a processing system that includes a first detection module configured to evaluate capacitive sensing data to identify a current location of an input object along a single axis, wherein the capacitive sensing data is measured using a plurality of sensor electrodes in a sensing region of an input device and a gesture detection module. The gesture detection module is configured to identify, using the current location, an entry in a data structure corresponding to the input object, wherein the data structure is configured to store multiple entries each corresponding to a different input object previously detected by the processing system and determine whether the input object has performed a predefined gesture by comparing the current location to a previous location of the input object on the single axis, wherein the previous location was stored in the identified entry.

Another embodiment described herein is a method that includes measuring capacitive sensing data using a plurality of sensor electrodes in a sensing region of an input device and evaluating the capacitive sensing data to identify a current location of an input object along a single axis. The method also includes identifying, using the current location, an entry in a data structure corresponding to the input object, wherein the data structure is configured to store multiple entries each corresponding to a different input object previously detected by a processing system and determining whether the input object has performed a predefined gesture by comparing the current location to a previous location of the input object on the single axis, wherein the previous location was stored in the identified entry.

### BRIEF DESCRIPTION OF DRAWINGS

So that the manner in which the above recited features of the present invention can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of an exemplary system that includes an input device in accordance with an embodiment of the invention;

FIGS. 2A and 2B illustrate portions of exemplary patterns of sensing elements or capacitive sensing pixels, according to embodiments described herein;

FIGS. 3A and 3B illustrate a tapping gesture along the side of an input device, according to one embodiment described herein;

FIGS. 4A and 4B illustrate capacitive sensing data corresponding to the tapping gesture in FIGS. 3A and 3B, according to one embodiment described herein;

FIGS. 5A and 5B illustrate a swiping gesture along the side of an input device, according to one embodiment described herein;

FIGS. 6A and 6B illustrate capacitive sensing data corresponding to the swiping gesture in FIGS. 5A and 5B, according to one embodiment described herein;

FIG. 7 is a flowchart for performing gesture recognition along a single axis, according to one embodiment described herein; and

FIG. 8 illustrates a processing system for performing gesture recognition along a single axis, according to one embodiment described herein.

To facilitate understanding, identical reference numerals have been used, where possible, to designate identical elements that are common to the figures. It is contemplated that elements disclosed in one embodiment may be beneficially utilized on other embodiments without specific recitation. The drawings referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION

The following detailed description is merely exemplary in nature and is not intended to limit the disclosure or its application and uses. Furthermore, there is no intention to be bound by any expressed or implied theory presented in the preceding technical field, background, brief summary or the following detailed description.

Various embodiments of the present invention provide input devices and methods that facilitate improved usability. In one embodiment, the input devices include sensing regions that permit the device to identify a location of input objects (e.g., a finger, thumb, palm, or stylus) along a side of the device. For example, the sensing region may include sensor electrodes that form a stack with display elements used to display images to the user. By performing capacitive sensing with the sensor electrodes, the input device can identify the location of input objects that are proximate to the side of the sensing region as well as input objects that are contacting or hovering above the sensing region. For example, the user may use her left hand to hold the device while using her right hand to touch the sensing region. Because a thumb or finger in the left hand is close enough to the sensing region to affect the sensing signals used when performing capacitive sensing, the input device can determine when, for example, a user performs a tapping gesture with her thumb on a first side of the input device or uses a finger to swipe a second side of the input device. In this manner, the sensing region can be used to identify a location of input object along a single axis (e.g., a side of the sensing region) in order to determine a predefined gesture.

In one embodiment, the input device includes a finger index (e.g., a data structure) for tracking information about input objects disposed at the side of the input device. By tracking the movement of the input objects along the side of the input device, the input device can determine if the user is performing a tapping or swiping gesture. The input device can also maintain separate records for tracking the gestures to determine if the user performs a combination gesture which relies on an input object performing multiple gestures—e.g., double tapping, swiping up and down in sequence, tapping on both sides of the input device in parallel, etc.

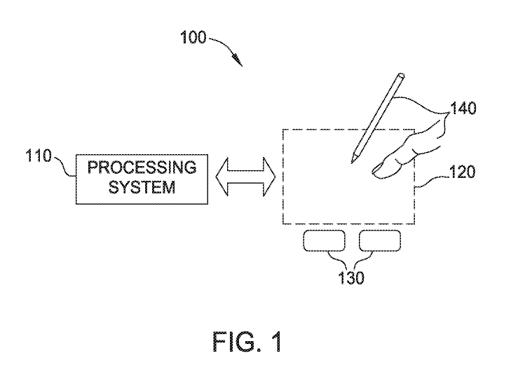

Turning now to the figures, FIG. 1 is a block diagram of an exemplary input device 100, in accordance with embodiments of the invention. The input device 100 may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 can be implemented as a physical part of the electronic system, or can be physically separate from the electronic system. As appropriate, the input device 100 may communicate with parts of the electronic system using any one or more of the following: buses, networks, and other wired or wireless interconnections. Examples include I²C, SPI, PS/2, Universal Serial Bus (USB), Bluetooth, RF, and IRDA.

In FIG. 1, the input device 100 is shown as a proximity sensor device (also often referred to as a “touchpad” or a “touch sensor device”) configured to sense input provided by one or more input objects 140 in a sensing region 120. Example input objects include fingers and styli, as shown in FIG. 1.

Sensing region 120 encompasses any space above, around, in and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g. a touch surface) of the input device 100, contact with an input surface of the input device 100 coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region 120 has a rectangular shape when projected onto an input surface of the input device 100.

The input device 100 may utilize any combination of sensor components and sensing technologies to detect user input in the sensing region 120. The input device 100 comprises one or more sensing elements for detecting user input. As several non-limiting examples, the input device 100 may use capacitive, elastive, resistive, inductive, magnetic, acoustic, ultrasonic, and/or optical techniques.

Some implementations are configured to provide images that span one, two, three, or higher dimensional spaces. Some implementations are configured to provide projections of input along particular axes or planes.

In some resistive implementations of the input device 100, a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device 100, one or more sensing elements pick up loop currents induced by a resonating coil or pair of coils. Some combination of the magnitude, phase, and frequency of the currents may then be used to determine positional information.

In some capacitive implementations of the input device 100, voltage or current is applied to create an electric field. Nearby input objects 140 cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object 140. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g. system ground), and by detecting the capacitive coupling between the sensor electrodes and input objects.

Some capacitive implementations utilize “mutual capacitance” (or “transcapacitance”) sensing methods based on changes in the capacitive coupling between sensor electrodes. In various embodiments, an input object 140 near the sensor electrodes alters the electric field between the sensor electrodes, thus changing the measured capacitive coupling. In one implementation, a transcapacitive sensing method operates by detecting the capacitive coupling between one or more transmitter sensor electrodes (also “transmitter electrodes” or “transmitters”) and one or more receiver sensor electrodes (also “receiver electrodes” or “receivers”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may comprise effect(s) corresponding to one or more transmitter signals, and/or to one or more sources of environmental interference (e.g. other electromagnetic signals). Sensor electrodes may be dedicated transmitters or receivers, or may be configured to both transmit and receive.

In FIG. 1, a processing system 110 is shown as part of the input device 100. The processing system 110 is configured to operate the hardware of the input device 100 to detect input in the sensing region 120. The processing system 110 comprises parts of or all of one or more integrated circuits (ICs) and/or other circuitry components. For example, a processing system 110 for a mutual capacitance sensor device may comprise transmitter circuitry configured to transmit signals with transmitter sensor electrodes, and/or receiver circuitry configured to receive signals with receiver sensor electrodes). In some embodiments, the processing system 110 also comprises electronically-readable instructions, such as firmware code, software code, and/or the like. In some embodiments, components composing the processing system 110 are located together, such as near sensing element(s) of the input device 100. In other embodiments, components of processing system 110 are physically separate with one or more components close to sensing element(s) of input device 100, and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In some embodiments, the processing system 110 responds to user input (or lack of user input) in the sensing region 120 directly by causing one or more actions. Example actions include changing operation modes, as well as GUI actions such as cursor movement, selection, menu navigation, and other functions. In some embodiments, the processing system 110 provides information about the input (or lack of input) to some part of the electronic system (e.g. to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions.

For example, in some embodiments, the processing system 110 operates the sensing element(s) of the input device 100 to produce electrical signals indicative of input (or lack of input) in the sensing region 120. The processing system 110 may perform any appropriate amount of processing on the electrical signals in producing the information provided to the electronic system. For example, the processing system 110 may digitize analog electrical signals obtained from the sensor electrodes. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device 100 is implemented with additional input components that are operated by the processing system 110 or by some other processing system. These additional input components may provide redundant functionality for input in the sensing region 120, or some other functionality. FIG. 1 shows buttons 130 near the sensing region 120 that can be used to facilitate selection of items using the input device 100. Other types of additional input components include sliders, balls, wheels, switches, and the like. Conversely, in some embodiments, the input device 100 may be implemented with no other input components.

In some embodiments, the input device 100 comprises a touch screen interface, and the sensing region 120 overlaps at least part of an active area of a display screen. For example, the input device 100 may comprise substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display screen may share physical elements. For example, some embodiments may utilize some of the same electrical components for displaying and sensing. As another example, the display screen may be operated in part or in total by the processing system 110.

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media readable by the processing system 110). Additionally, the embodiments of the present invention apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

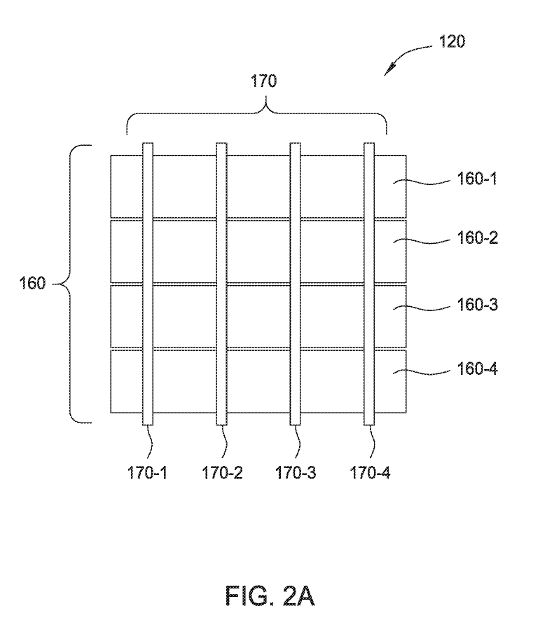

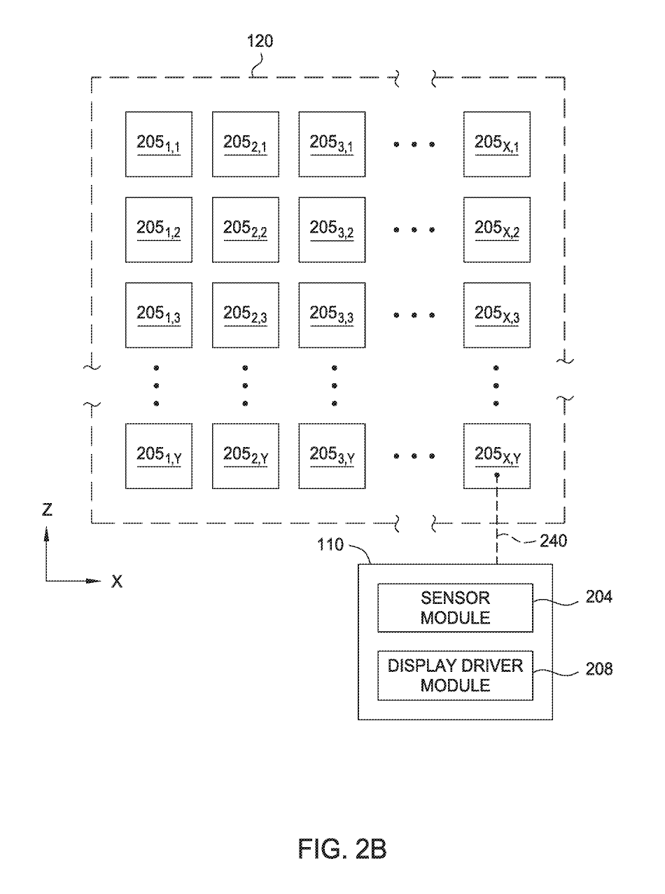

FIG. 2A shows a portion of an exemplary pattern of sensing elements configured to sense in a sensing region 120 associated with the pattern, according to some embodiments. For clarity of illustration and description, FIG. 2A shows the sensing elements in a pattern of simple rectangles, and does not show various components. This pattern of sensing elements comprises a first plurality of sensor electrodes 160 (160-1, 160-2, 160-3, . . . 160-n), and a second plurality of sensor electrodes 170 (170-1, 170-2, 170-3, . . . 170-n) disposed over the plurality of sensor electrodes 160. In one embodiment, this pattern of sensing elements comprises a plurality of transmitter electrodes 160 (160-1, 160-2, 160-3, . . . 160-n), and a plurality of receiver electrodes 170 (170-1, 170-2, 170-3, . . . 170-n) disposed over the plurality of transmitter electrodes 160. In another embodiment, the first plurality of sensor electrodes may be configured to transmit and receive and the second plurality of sensor electrodes may also be configured to transmit and receive.

Transmitter electrodes 160 and receiver electrodes 170 are typically ohmically isolated from each other. That is, one or more insulators separate transmitter electrodes 160 and receiver electrodes 170 and prevent them from electrically shorting to each other. In some embodiments, transmitter electrodes 160 and receiver electrodes 170 are separated by insulative material disposed between them at cross-over areas; in such constructions, the transmitter electrodes 160 and/or receiver electrodes 170 may be formed with jumpers connecting different portions of the same electrode. In some embodiments, transmitter electrodes 160 and receiver electrodes 170 are separated by one or more layers of insulative material. In such embodiments, the transmitter electrodes and receiver electrodes may be disposed on separate layers of a common substrate. In some other embodiments, transmitter electrodes 160 and receiver electrodes 170 are separated by one or more substrates; for example, they may be disposed on opposite sides of the same substrate, or on different substrates that are laminated together.

The areas of localized capacitive coupling between transmitter electrodes 160 and receiver electrodes 170 may be termed “capacitive pixels.” The capacitive coupling between the transmitter electrodes 160 and receiver electrodes 170 change with the proximity and motion of input objects in the sensing region associated with the transmitter electrodes 160 and receiver electrodes 170.

In some embodiments, the sensor pattern is “scanned” to determine these capacitive couplings. That is, the transmitter electrodes 160 are driven to transmit transmitter signals. The receiver sensor electrodes 170 may be operated singly or multiply to acquire resulting signals. The resulting signals may be used to determine measurements of the capacitive couplings at the capacitive pixels.

A set of measurements from the capacitive pixels form a “capacitive image” (also “capacitive frame”) representative of the capacitive couplings at the pixels. Multiple capacitive images may be acquired over multiple time periods, and differences between them used to derive information about input in the sensing region. For example, successive capacitive images acquired over successive periods of time can be used to track the motion(s) of one or more input objects entering, exiting, and within the sensing region.

The baseline capacitance of a sensor device is the capacitive image associated with no input object in the sensing region. The baseline capacitance changes with the environment and operating conditions, and may be estimated in various ways. For example, some embodiments take “baseline images” when no input object is determined to be in the sensing region, and use those baseline images as estimates of their baseline capacitances.

Capacitive images can be adjusted for the baseline capacitance of the sensor device for more efficient processing. Some embodiments accomplish this by “baselining” measurements of the capacitive couplings at the capacitive pixels to produce a “baselined capacitive image.” That is, some embodiments compare the measurements forming a capacitance image with appropriate “baseline values” of a “baseline image” associated with those pixels, and determine changes from that baseline image.

FIG. 2B shows a portion of an exemplary pattern of capacitive sensing pixels 205 (also referred to herein as capacitive pixels or sensing pixels) configured to sense in the sensing region 120 associated with a pattern, according to some embodiments. Each capacitive pixel 205 may include one of more of the sensing elements described above. For clarity of illustration and description, FIG. 2 presents the regions of the capacitive pixels 205 in a pattern of simple rectangles and does not show various other components within the capacitive pixels 205. In one embodiment, the capacitive sensing pixels 205 are areas of localized capacitance (capacitive coupling). Capacitive pixels 205 may be formed between an individual sensor electrode and ground in a first mode of operation and between groups of sensor electrodes used as transmitter and receiver electrodes in a second mode of operation. The capacitive coupling changes with the proximity and motion of input objects in the sensing region 120 associated with the capacitive pixels 205, and thus may be used as an indicator of the presence of the input object in the sensing region 120 of the input device.

The exemplary pattern comprises an array of capacitive sensing pixels 205X,Y (referred collectively as pixels 205) arranged in X columns and Y rows in a common plane, wherein X and Y are positive integers, although one of X and Y may be zero. It is contemplated that the pattern of sensing pixels 205 may comprises a plurality of sensing pixels 205 having other configurations, such as polar arrays, repeating patterns, non-repeating patterns, non-uniform arrays a single row or column, or other suitable arrangement. Further, as will be discussed in more detail below, the sensor electrodes in the sensing pixels 205 may be any shape such as circular, rectangular, diamond, star, square, noncovex, convex, nonconcave concave, etc. As shown here, the sensing pixels 205 are coupled to the processing system 110 and utilized to determine the presence (or lack thereof) of an input object in the sensing region 120.

In a first mode of operation, at least one sensor electrode within the capacitive sensing pixels 205 may be utilized to detect the presence of an input object via absolute sensing techniques. A sensor module 204 in processing system 110 is configured to drive a sensor electrode using a trace 240 in each pixel 205 with a modulated signal (i.e., a capacitive sensing signal) and measure a capacitance between the sensor electrode and the input object (e.g., free space or earth ground) based on the modulated signal, which is utilized by the processing system 110 or other processor to determine the position of the input object.

The various electrodes of capacitive pixels 205 are typically ohmically isolated from the electrodes of other capacitive pixels 205. Additionally, where a pixel 205 includes multiple electrodes, the electrodes may be ohmically isolated from each other. That is, one or more insulators separate the sensor electrodes and prevent them from electrically shorting to each other.

In a second mode of operation, sensor electrodes in the capacitive pixels 205 are utilized to detect the presence of an input object via transcapacitance sensing techniques. That is, processing system 110 may drive at least one sensor electrode in a pixel 205 with a transmitter signal and receive resulting signals using one or more of the other sensor electrodes in the pixel 205, where a resulting signal comprising effects corresponding to the transmitter signal. The resulting signal is utilized by the processing system 110 or other processor to determine the position of the input object.

The input device 100 may be configured to operate in any one of the modes described above. The input device 100 may also be configured to switch between any two or more of the modes described above.

In some embodiments, the capacitive pixels 205 are “scanned” to determine these capacitive couplings. That is, in one embodiment, one or more of the sensor electrodes are driven to transmit transmitter signals. Transmitters may be operated such that one transmitter electrode transmits at one time, or multiple transmitter electrodes transmit at the same time. Where multiple transmitter electrodes transmit simultaneously, the multiple transmitter electrodes may transmit the same transmitter signal and effectively produce an effectively larger transmitter electrode. Alternatively, the multiple transmitter electrodes may transmit different transmitter signals. For example, multiple transmitter electrodes may transmit different transmitter signals according to one or more coding schemes that enable their combined effects on the resulting signals of receiver electrodes to be independently determined.

The sensor electrodes configured as receiver sensor electrodes may be operated singly or multiply to acquire resulting signals. The resulting signals may be used to determine measurements of the capacitive couplings at the capacitive pixels 205.

A set of measurements from the capacitive pixels 205 form a capacitive image (also capacitive frame) representative of the capacitive couplings at the pixels 205 as discussed above. Multiple capacitive images may be acquired over multiple time periods, and differences between them used to derive information about input in the sensing region. For example, successive capacitive images acquired over successive periods of time can be used to track the motion(s) of one or more input objects entering, exiting, and within the sensing region.

Continuing to refer to FIG. 2B, the processing system 110 coupled to the sensing electrodes includes a sensor module 204 and optionally, a display driver module 208. In one embodiment the sensor module 204 comprises circuitry configured to drive a transmitter signal or a modulated signal onto and receive resulting signals with the resulting signals the sensing electrodes during periods in which input sensing is desired. In one embodiment the sensor module 204 includes a transmitter module including circuitry configured to drive a transmitter signal onto the sensing electrodes during periods in which input sensing is desired.

In various embodiments the sensor module 204 may comprise a receiver module that includes circuitry configured to receive a resulting signal with the sensing electrodes comprising effects corresponding to the transmitter signal during periods in which input sensing is desired. The receiver module may determine a position of the input object in the sensing region 120 or may provide a signal including information indicative of the resulting signal to another module or processor, for example, a determination module or a processor of the electronic device (i.e., a host processor), for determining the position of the input object in the sensing region 120. In one or more embodiments, the receiver module comprises a plurality of receivers, where each receiver may be an analog front ends (AFEs).

The display driver module 208 includes circuitry confirmed to provide display image update information to the display of the display device during non-sensing (e.g., display updating) periods. The display driver module 208 may be included with or separate from the sensor module 204. In one embodiment, the processing system comprises a first integrated controller comprising the display driver module 208 and at least a portion of the sensor module 204 (i.e., transmitter module and/or receiver module). In another embodiment, the processing system comprises a first integrated controller comprising the display driver module 208 and a second integrated controller comprising the sensor module 204. In yet another embodiment, the processing system comprises a first integrated controller comprising a display driver module 208 and one of a transmitter module or a receiver module and a second integrated controller comprising the other one of the transmitter module and receiver module.

The discussion above regarding FIGS. 2A and 2B describes various sensor arrangements suitable for sensing along a single axis. However, the techniques described herein can be applied to any sensor arrangement suitable to collect data along a single axis such as the top, bottom or sides of the sensing region 120 or the arrangement of the sensor electrodes. Moreover, the embodiments herein can be used with either transcapacitive or absolute sensing techniques in order to identify gestures as an input object (e.g., a finger) moves along an axis.

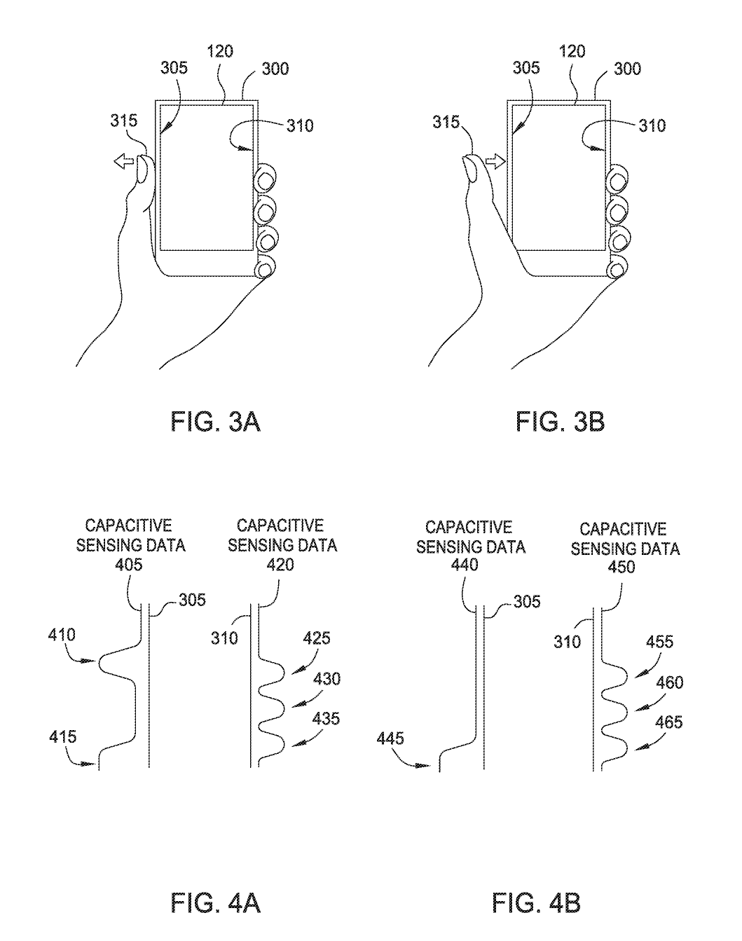

FIGS. 3A and 3B illustrate a tapping gesture along the side of an input device. Specifically, FIG. 3A illustrates an input device 300 that includes the sensing region 120 which may include any of the sensor electrode arrangements described above. In one embodiment, the sensing region 120 is integrated with a display for displaying images to the user. Capacitive sensing can be used to permit the user to interact with the displayed image by, for example, entering text, opening applications, moving icons, interacting with graphical buttons, and the like. For example, the user may use an input object such as a finger or stylus to contact or hover over specific locations in the sensing region 120 in order to interact with displayed content.

In addition to detecting an input object directly above the sensing region 120, the input device 300 identifies a location of input objects to the side of the sensing region 120. In this example, the sensing region 120 includes a left side 305 and a right side 310 that are proximate to the fingers or palm of the user holding the input device 300. As shown, the fingers and palm are not directly above the sensing region 120 as defined by a direction perpendicular to the sensing region 120. Using the sensor electrodes in the sensing region 120, the input device 300 measures capacitive sensing data that indicates a location of the fingers or palm along the left and right sides 305 and 310 of the sensing region 120. While the input device 300 can include separate sensor electrodes that are not part of repetitive pattern that defines the main sensor electrode array in the sensing region 120 and are outside of the display area of the input device 300, in this embodiment, the location of the fingers or palm is detected using only the sensor electrodes in the sensing region 120—e.g., the sensor electrodes that are disposed in, or on, a display of the input device 300—which may reduce costs.

When performing capacitive sensing, the input device 300 measures capacitive sensing signals on the sensor electrodes which are affected by the capacitive coupling between the sensor electrodes in the sensing region 120 and the input objects disposed along the sides of the input device. After processing these signals, the input device 300 can identify the location of input objects such as the fingers and the palm along the sides 305 and 310 of the sensing region 120 which also corresponds to sides of the sensor electrode layout. Stated differently, the input device 300 performs capacitive sensing region along a single axis to determine a location of input objects along this axis. In this embodiment, the single axis is defined by side 305 of the underlying sensor electrodes which establish the sensor region 120. Moreover, although sensing region 120 is illustrated as not extending beyond the sides of the input device 300, because in the embodiments below the input device 300 senses input object that are disposed at or proximate to (e.g., less than a centimeter) a side of the input device 300, the sensing region 120 can be considered as extending to, or beyond, the sides of the input device 300 so that the capacitive sensing signals measured using the sensor electrodes can be used to identify a location of an input object at the side of the input device along a single axis.

Moreover, the input device 300 may identify the location of the input objects along different axes such as along the axes defined by sides 305 and 310 as well as along axes defined by the top and bottom of the sensor electrode layout in the region 120. Put differently, in one embodiment, the input device 300 determines the location of input objects that are proximate to both of the sides 305 and 310. As described in more detail below, the location information can be processed to determine a change in position of the input object, velocity of the input object, acceleration of the input object, and the like. Moreover, although FIGS. 3A and 3B illustrate fingers or a palm interacting with the sides 305 and 310, in other embodiments, the user may use a stylus or other input objects such as an active pen to interact with the sides 305 and 310.

In addition to detecting the location of input objects along the left and right sides 305 and 310, the input device 300 can also detect an input object along the top or bottom sides of the device 300. However, if the sensing region 120 is spaced too far from an external side of the device 300 (e.g., greater than 1 cm), the input device 300 may be unable to sense an input object. For example, if the sensing region 120 does not extend to the bottom of the input device 300—e.g., to leave space for physical buttons—the input device 300 may identify input objects proximate to only the top side, left side 305 and the right side 310 of the sensing region 120.

As shown in FIG. 3A, a thumb 315 of the user holding the input device 300 is currently contacting a side of the input device 300 near the left side 305 of the sensing region 120. While at this location, the capacitive coupling between the thumb 315 and the sensor electrodes in the region 120 permit the input device 300 to identify the location of the thumb 315 along the axis defined by the left side 305 of the sensor electrodes in the region 120. However, as the arrow indicates, the user moves the thumb 315 in a direction away from side 305 so that the capacitive coupling between the thumb 315 and the sensor electrodes in the sensing region 120 is reduced.

FIG. 3B illustrates a time period when the thumb 315 has extended away from the left side 305 such that the capacitive coupling between the thumb 315 and the sensor electrodes does not have a substantial effect on the capacitive sensing signals measured by the input device 300. Stated differently, the input device 300 can no longer identify a location of the thumb 315 along the left side 305. As indicated by the arrow, the user then moves the thumb 315 back towards the left side 315 until the thumb is again sufficiently close to the input device 300 so that the sensing region 120 can identify a location of the thumb 315 along the axis defined by the left side 305. As will be described in detail below, the input device 300 can evaluate capacitive sensing data measured during multiple capacitive frames to identify a tapping gesture where the user lifts an input object away from a side and then places the object back at approximately the same location. Once identified, this gesture can trigger a corresponding action such as navigating to a home screen, opening an application, closing an application, etc.

FIGS. 4A and 4B illustrate capacitive sensing data corresponding to the tapping gesture in FIGS. 3A and 3B. Specifically, FIG. 4A illustrates capacitive sensing data 405 that corresponds to the left side 305 of the sensing region 120 when the hand of the user is positioned as shown in FIG. 3A. In one embodiment, the capacitive sensing data 405 is derived by subtracting capacitive sensing measurements derived using the sensor electrodes from baseline measurements. Doing so results in the capacitive sensing data 405 (also referred to as delta signals) that indicate locations along the axis defined by the left side 305 where the capacitive sensing measurements differ from the baseline measurements. The data 405 includes two portions (i.e., portions 410 and 415) which indicate the presence of an input object. Specifically, portion 410 corresponds to thumb 315 while portion 415 corresponds to the palm of the user which contacts the input device 300 near the lower part of the left side 305 of the sensing region 120. The portions 410 and 415 can be projected onto the left side 305 to identify a location of the input objects along the axis defined by the side 305.

Moreover, FIG. 4A also illustrates capacitive sensing data 420 indicating the location of the fingers on the right side 310. As shown, there are three portions in the data 420 (i.e., portions 425, 430, and 435) which differ from the baseline measurements. Each of these portions corresponds to one of the fingers shown in FIG. 3A which are proximate to the right side 310 of sensing region 120. Although there are four fingers contacting the rightmost side of the input device 300, in this example, it is assumed the bottom finger is too far from the right side 310 of the sensing region 120 to affect the capacitive sensing data 420. Stated differently, the sensing region 120 does not extend far enough down to location of the bottom finger. Thus, the location of the bottommost finger is not represented in the capacitive sensing data 420. However, using data 420, the input device 300 can identify the location of the top three fingers along the axis defined by the right side 310.

FIG. 4B illustrates capacitive sensing data 440 that corresponds to the left side 305 when the hand of the user is positioned as shown in FIG. 3B. That is, data 440 represents the location of an input object relative to the side 305 when the thumb 315 is extended away from the input device 300. Because the thumb 315 no longer has a substantial effect on the capacitive sensing measurements captured by the sensor electrodes in the sensing region, the capacitive sensing data 440 does not have a peak that identifies a location of the thumb 315 along the axis defined by side 305. Put differently, moving the thumb 315 away from the left side of the sensing region causes the peak at portion 410 of the capacitive sensing data 405 shown in FIG. 4A to shrink until there is no longer a bulge in the data 440 as shown in FIG. 4B. As discussed in more detail below, the input device can use the data 440 to recognize that the input object has moved away from the leftmost side of the input device and use this knowledge to perform gesture detection.

Portion 445 of capacitive sensing data 440 indicates that the palm of the user is still proximate to the left side of the sensing region. Thus, portion 445 may be the same as portion 415 of capacitive sensing data 405. However, moving the palm away from the left side of the sensing region would cause the peak at portion 445 to shrink. In contrast, if the user squeezed the input device tighter, thereby moving a larger portion of the palm closer to the left side 305 of the sensing region, the peak at portion 445 would increase. The amplitude of the capacitive sensing data 440 (which corresponds to the difference between the measured capacitive sensing signals and the baseline measurements) increases as the input object has a greater effect on the capacitive sensing signals measured by the sensor electrodes in the sensing region.

FIG. 4B also illustrates capacitive sensing data 450 corresponding to the right side 310 of the sensing region 120 shown in FIG. 3B. Because the fingers have not moved relative to their position in FIG. 3A, the location and amplitude of portions 455, 460, and 465 in capacitive sensing data 450 is approximately the same as portions 425, 430, and 435 in capacitive sensing data 420 in FIG. 4A.

Furthermore, as indicated by the arrow in FIG. 3B, the user moves her thumb 315 such that the thumb 315 again contacts the input device 300 and is proximate to the left side 305 of the sensing region. As a result, when a new capacitive frame is generated, the capacitive sensing data corresponding to the left side 305 would look similar to the capacitive sensing data 405 in FIG. 4A where a peak appears at portion 410 indicating the presence of an input object at the corresponding position on the left side 305. Using the techniques described above, the input device 300 can determine that the user performed a tapping gesture using the thumb 315, and in response, trigger a corresponding action.

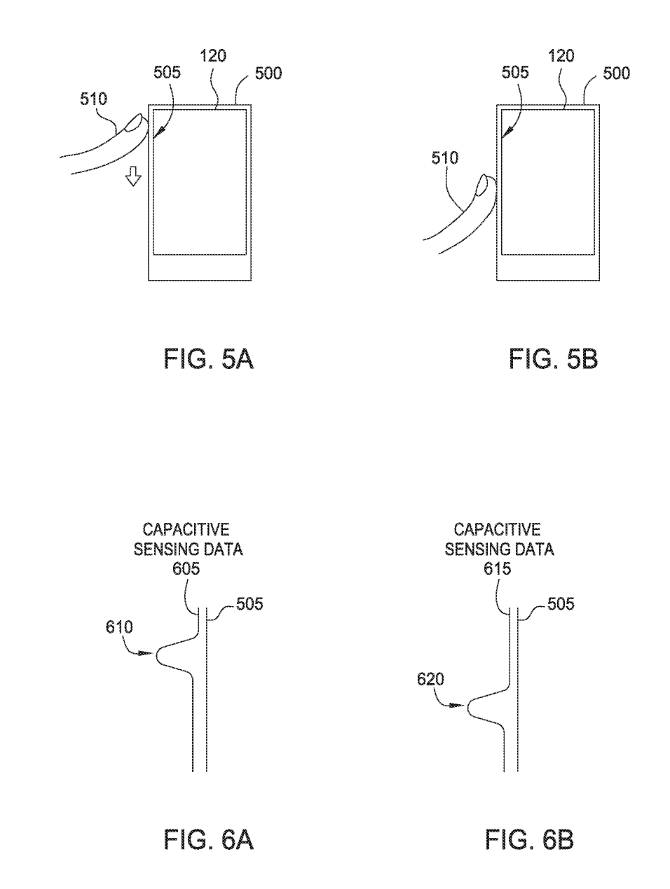

FIGS. 5A and 5B illustrate a swiping gesture along the side of an input device 500. In FIG. 5A, the user moves a finger 510 along the side of the input device 500 which is proximate to a left side 505 of the sensing region 120. As shown by the arrow, the user moves the finger 510 towards the bottom of the input device 500. FIG. 5B illustrates the result of the sliding gesture where the finger 510 has now moved to a different location along the left side 505 of the sensing region 120.

FIGS. 6A and 6B illustrate capacitive sensing data corresponding to the swiping gesture in FIGS. 5A and 5B. Specifically, FIG. 6A illustrates capacitive sensing data 605 that includes a peak at portion 610. When projected onto the left side 605, the peak at portion 610 indicates the location of the finger 510 along the axis defined by the side 605 of the sensor electrodes. Evaluating the capacitive sensing data 605 permits the input device 500 to identify a location of the finger 510 relative to the sensing region 120.

FIG. 6B illustrates capacitive sensing data 615 which includes a peak at portion 620. Because the finger 510 has slid down the side of the input device 500 as shown in FIG. 5B, the location of portion 620 is further down along the left side 505 than the location of portion 610 in FIG. 6A. Thus, by tracking the movement of the input object over several capacitive image frames, the input device 500 can determine the user is performing a sliding gesture using the finger 510. Although not shown, the input device 500 may have captured several capacitive image frames between the times illustrated in FIGS. 5A and 5B that output capacitive sensing data having peaks at locations between the locations shown by portions 610 and 620. By comparing these capacitive frames, the input device 500 can identify a change in position, velocity, and/or acceleration corresponding to the finger 510 which may aid the device 500 to identify the sliding gesture.

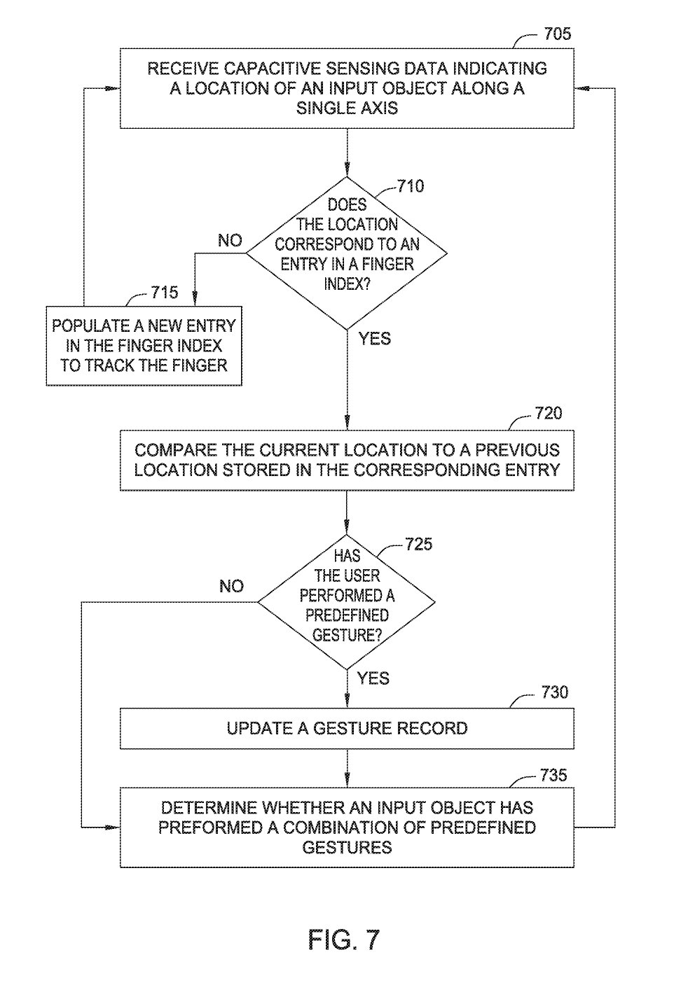

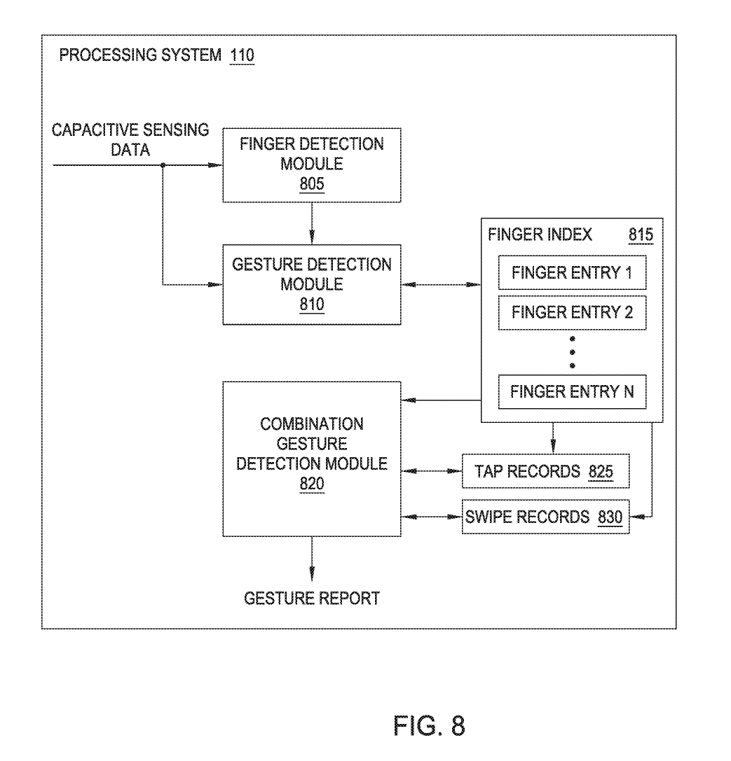

FIG. 7 is a flowchart of a method 700 for performing gesture recognition along a single axis. In one embodiment, the single axis is defined by a side of a sensor electrode layout forming a sensing region in an input device. Moreover, the axis may be parallel to the plane of the sensor electrodes. For ease of explanation, the different blocks in method 700 are discussed in tandem with FIG. 8, which illustrates a processing system 110 for performing gesture recognition along the single axis.

Method 700 begins at block 705 where the processing system 110 receives capacitive sensing data indicating a location of an input object along a single axis. As illustrated in FIGS. 4A, 4B, 6A, and 6B above, the capacitive sensing data may include peaks that correspond to input objects that are proximate to a side of a sensing region. That is, the local maximums in the capacitive sensing data can be projected along an axis defined by a side of the sensor electrode layout to identify a location of the input object relative to the sensing region.

The processing system 110 includes a finger detection module 805 that processes the capacitive sensing data to identify the location of input objects at the sides of the sensing region. In one embodiment, the module 805 (which can be hardware or firmware operating in the system 110) scans the capacitive sensing data to identify peaks that correspond to input objects proximate to the sides of the sensing region. The finger detection module 805 may then project these peaks onto a predefined axis to determine the location of the input object along the side of the sensing region.

In one embodiment, the finger detection module 805 identifies input objects on multiple axes defined by the sensing region. In one example, the capacitive sensing data may enable the detection module 805 to identify the location of input objects along the left and right sides of the sensing region. However, in another example, the module 805 may identify the location of input object along the top and bottom of the sensing region. Further still, the finger detection module 805 may determine locations of input objects along all four sides (e.g., on four axes).

At block 710, the processing system determines if the location of the input object corresponds to an entry in a finger index 815. In FIG. 8, a gesture detection module 810 receives the current location of the input object (or objects) from the finger detection module 805. The gesture detection module 810 compares the current location to location data stored in the entries of the finger index 815. In one embodiment, each entry in the index 815 corresponds to a different input object previously identified by the processing system 110. For example, finger entry 1 may correspond to a pointer finger while finger entry 2 corresponds to a ring finger. These entries may be populated when the processing system evaluated previous capacitive frames. Moreover, although the embodiments below describe generating entries in the index 815 that each correspond to a different identified finger, this disclosure is not limited to such. The index 815 may also include entries for other types of input objects such as a palm of the hand or a stylus.

The entries in the index 815 may each store past locations of the input object which were identified using capacitive sensing data corresponding to previous capacitive frames. The gesture detection module 810 may scan through the entries in the finger index 815 to determine if the current location received from the finger detection module 805 matches a saved location in one of the entries. In one embodiment, the module 810 determines whether the current location is within a predefined threshold distance from one of the saved locations in the index 815. If the gesture detection module 810 determines that the current location does not match any of the locations in the entries, method 700 proceeds to block 715 where the gesture detection module 810 populates a new entry in the finger index 815 to track the finger. Put differently, because the current location does not match any of fingers currently being tracked in the finger index 815, the processing system assumes this is a new input object and stores the location of the object in a new entry in the index 815. Once the new entry is populated, method 700 returns to block 705 and the processing system waits for updated capacitive sensing data for the next capacitive frame (assuming the processing system has evaluated all the peaks in the current capacitive sensing data).

However, if at block 710 the gesture detection module 810 determines the current location does match one of the saved locations in the index 815, method 700 proceeds to block 720 where the gesture detection module compares the current location to a previous location stored in the corresponding entry to determine whether the user has performed a predefined gesture. Put differently, if the locations match, the module 810 determines the peak corresponds to an input object that has already been identified by the processing system 110 in a previous capacitive frame. Although the embodiments below describe using the information stored in the finger index 815 to determine if the user performed a tapping gesture or a swiping gesture, this disclosure is not limited to such and can be used to identify any type of gesture made along a single axis.

To determine if the current location indicates that the input object has completed a tapping gesture, in one embodiment, the gesture detection module 810 determines if the input object has been lifted off (or has disappeared) during previous capacitive frames but has now returned to its previous stored location. For example, when a new entry is populated in the finger index 815, the gesture detection module 810 may change a state of a lift-off flag stored in the entry indicating the input object is currently proximate to a side of the sensing region as shown in, e.g., FIG. 3A where the thumb 315 contacts the side of the input device 300. Later, the user may move the thumb 315 such that its location is no longer represented in the capacitive sensing data as shown in FIG. 3B where the thumb 315 has moved away from the input device 300. For example, for each capacitive frame, the gesture detection module 810 may evaluate the locations in the capacitive sensing data corresponding to previously identified input objects to determine if those objects are still proximate to the sensing region. To do so, the module 810 may monitor the amplitude of the capacitive sensing signal at these locations to determine if it falls below a threshold amplitude. In response to determining the input object has moved away from the sensing region, the gesture detection module 810 changes the lift-off flag in the entry to indicate the input object has moved away from the sensing region.

Once the gesture detection module 810 determines the input object has moved away from the side of the input device, in one embodiment, the module 810 resets the entry for that input object in the finger index 815 to a default state. In the case the input object performed a gesture while lifting such as tapping or swiping, this gesture is recorded in the tap record 825 or swipe record 830. Thus, the information stored in the tap and swipe records 825 and 830 can be used to determine when the tap or swipe was completed. The information in the finger index 815, however, is erased.

In another embodiment, even after the gesture detection module 810 determines the input object has moved away from the side of the input device, the entry for the object in the finger index 815 is maintained. In this example, the entry in the index 815 records the last known position of the input object along the axis. Thus, when the finger detection module 805 identifies a location of a peak in updated capacitive sensing data that matches the last known location of the input object, the gesture detection module 810 can determine that the input object has returned to its previous location. Put differently, because the locations match, the gesture detection module 810 assumes it is the same input object that was previously detected rather than a new input object.

In one embodiment, the gesture detection module 810 determines the user has performed a tapping gesture if the time between when the input object moved away from the sensing region and returned to the sensing region is within a predefined threshold. Assuming the threshold is half a second, if the user moves the input object away from the input device and then returns the object to the same location along the side of the sensing region one second later, the module 810 would not characterize the action as a tapping gesture. Similarly, if the user moved the input object away and brought the object back to the input device with the time threshold but the last known location of the input object and the current location are not within a predefined distance from each other, the gesture detection module 810 would not characterize the movement as a tapping gesture. Thus, in this example, the timing and movement of the tapping gesture must satisfy separate thresholds in order for the action to be characterized as a tapping gesture.

To determine if the movement of an input object is a swipe gesture, the gesture detection module 810 tracks the movement of the input object over several capacitive frames. In one embodiment, the gesture detection module 810 may use different thresholds to determine if the current location corresponds to a new input object or if the input object as simply moved. For example, if the current location is more than centimeter from any previous stored locations of the identified input objects, then method 700 may at block 710 determine the current location is a result of a new input object being brought near the sensing region and populate a new entry in the index 815. However, if the current location is within a centimeter of a previous location stored in the finger index 815, the gesture detection module 810 determines the current location corresponds to a new location of a previously identified input object—e.g., an input object as moved along the axis as shown by the sliding finger 510 in FIGS. 5A and 5B.

In one embodiment, each entry in the finger index 815 stores a counter that indicates how many capacitive frames the finger has moved. For example, if the input object moves at least two millimeters relative to its location in the previous capacitive frame, the gesture detection module 810 increments the counter in the entry. In one embodiment, each entry may include two counters: one for tracking how often the input object moves along a first direction on the axis and a second counter for tracking how often the input object moves along a second, opposite direction on the axis. If the counter reaches a predetermined number (e.g., the input object moves at least two millimeters at least five times), the gesture detection module 810 determines that the user has performed a swiping gesture using the input object. In one embodiment, the gesture detection module 810 may wait until there is a lift off event before evaluating the counters to determine if the user performed the swiping gesture.

The gesture detection module 810 may reset the counters if the movements stops or changes directions. For example, if the user moves the input object more than two millimeters for three consecutive capacitive frames but then its location remains stationary for, e.g., the next five capacitive frames, the gesture detection module 810 may reset the counter. Similarly, if the user moves the input object in the first direction for three capacitive frames but then moves the input object in the second direction the next two frames, the gesture detection module 810 may reset the counter corresponding to the first direction. In this manner, the gesture detection module 810 can ensure the user has performed a substantially continuous swiping motion in a single direction before characterizing the user action as a swiping gesture.

In another embodiment, the gesture detection module 810 determines a swiping gesture depending on the distance the input object moves over several capacitive frames. For example, instead of maintaining counters, the entry in the finger index 815 may store the previous locations of the input object over several frames—e.g., the previous five or ten frames. By comparing the current location to the previously stored locations, the gesture detection module 810 can determine the absolute distance moved by the input object over a set period of time (based on the timing of the capacitive frames). The gesture detection module 810 can determine if the distance between the current location and the oldest stored location in the entry exceeds a threshold distance before characterizing the movement as a swiping motion. Alternatively, the gesture detection module 810 can use the stored locations of the input object and the timing of the capacitive frames to calculate a velocity or speed of the input object. If the velocity exceeds a threshold, the gesture detection module 810 indicates a swiping gesture was performed.

The entries in the finger index 815 may store other information useful to determine if the user has performed a gesture besides the information explained above (i.e., movement counters, previous locations, a lift-off flag, etc.). For example, the entries may store the starting location of the input object when the entry was first populated, the number of capacitive frames the input object has been detected by the finger detection module 805, the maximum amplitude of the peak in the capacitive sensing data corresponding to the input object, the area covered by the input object, and the like. This information may also be used to identify a predefined gesture as well as perform other tasks such as classifying the input object (e.g., whether the object is a finger or a palm).

At block 725, the gesture detection module 810 determines if the user performed a predefined gesture (e.g., a tapping or swiping gesture) as described above. For example, the capacitive sensing data may include multiple peaks that correspond to different input objects. The gesture detection module 810 may evaluate each of these peaks to determine if these peaks (along with the information stored in the index 815) indicate that the user has completed a predefined gesture. If so, method 700 proceeds to block 730 where the gesture detection module 810 updates a gesture record. In FIG. 8, the processing system 110 includes both tap records 825 and swipe records 830 for tracking when a tapping or swiping gesture is identified.

Each time a tap or swipe is identified, the gesture detection module 810 updates the tap or swipe records to indicate which entry (i.e., which input object) performed the gesture. For example, the tap records 825 for a particular input object may increment each time a tap is detected. Moreover, the tap records 825 may record the time between taps or swipes. In this manner, the processing system 110 can track the number of times and how often a particular gesture is performed using an input object. However, if the gesture detection module 810 does not identify a gesture based on the location provided by the capacitive sensing data, method 700 proceeds from block 725 to block 735.

At block 735, a combination gesture detection module 820 determines whether an input object has performed a combination of predefined gestures. To do so, the combination gesture detection module 820 evaluates the finger index 815, tap records 825, and swipe records 830 to determine if the individual gestures identified by the gesture detection module 810 should be combined and identified as a combination gesture—e.g., double tapping, swiping up and down in sequence, tapping on both sides of the input device in parallel, and the like. For example, if an input device has two taps stored in the tap records 825, the module 820 determines if these taps occurred within a predefined time window using timing information stored either in the tap records 825 or the corresponding entry in the finger index 815—e.g., the number of frames that have elapsed since the first tap occurred. Moreover, the module 820 may check to ensure the two separate tapping gestures occurred at substantially the same location on the axis (e.g., within five millimeters) before combining the two gestures into a combination gesture. In another embodiment, the combination gesture detection module 820 may evaluate the amplitude of the capacitive sensing data captured when detecting the tapping gesture to ensure the amplitudes are similar or exceed a threshold before combining the gestures into a single combination gesture.

To characterize single tapping gestures on different sides of the sensing region as a combination gesture, the combination gesture detection module 820 may determine whether the two taps occurred within a predefined number of frames of each other. The module 820 may also determine if the amplitudes of the taps are within a predefined threshold or that the two input objects moved away from their respective sides of the input device around the same time before characterizing the two taps as a combination gesture.

The combination gesture detection module 820 may perform a similar analysis using the swipe records 830. For example, the module 820 may determine that a swipe up and a swipe down should be combined into a single combination gesture if the swipes occur within a predefined number of frames from each other and if the end location of the swipe up is the beginning location of the swipe down. Moreover, the processing system 110 may define combination gestures that are a combination of tapping and swiping gestures.

In one embodiment, the processing system 110 waits a predetermined number of capacitive frames or time limit before reporting the gestures to a host processor in the input device. For example, instead of immediately reporting a tapping or swiping gesture identified by the gesture detection module 810, the processing system 110 may wait a predefined number of frames so that the user has time to perform a combination gesture. For instance, the user may have performed only the first tap in a double tapping gesture. The processing system 110 waits to ensure the user is not going to perform a second tap before reporting out the first tap to the host processor. Because of this delay, the input device can perform different actions depending on whether the gesture is a single gesture or a combination gesture. For example, a single tap may cause the input device to return to a home screen while a double tap causes the input device to open a preselected favorite application. Similarly, a swipe up may cause an option screen to rise from the bottom of the display while a swipe up followed by a swipe down causes the current application being displayed to minimize.

In one embodiment, the combination gesture detection module 820 monitors the timing between different tapping gestures to see if the taps match a predefined pattern. For example, the module 820 may evaluate the timing corresponding to the tapping gesture to determine if the taps correspond to Morse code. That is, the module 820 may identify long or short taps in succession which can be translated to a letter using Morse code.

If a combination gesture is identified, the module 820 may delete the corresponding individual gestures saved in the tap and swipe records 825 and 830. For example, if the user performed a simultaneous tap on each side of the input device using different input objects, the module 820 may delete these taps from the record 825. A similar reset may be performed if a swipe stored in the swipe records 830 was identified as part of a combination gesture. After evaluating the individual gestures to determine if a combination gesture was performed, the method 700 returns to block 705 to wait for capacitive sensing data for the next capacitive frame. As such, method 700 may repeat each capacitive frame to identify individual and combination gestures.

Although the embodiments above describe detecting the location of an input object on a side (or sides) of a two or three dimensional sensing region, this disclosure is not limited to such. For example, the gesture detection techniques above may be used in a one dimensional sensor for identifying gestures. In one example, one or more sensor electrodes may be placed along a pen or other small cylindrical object for performing gesture recognition along a single axis defined by the sensor electrodes. Put differently, the sensor electrodes may be able to perform capacitive sensing only in the direction defined by the axis unlike sensing region 120 described above which can perform two or three dimensional sensing as well as one-dimensional sensing for input objects located on the sides of the input device.

The embodiments and examples set forth herein were presented in order to best explain the embodiments in accordance with the present technology and its particular application and to thereby enable those skilled in the art to make and use the present technology. However, those skilled in the art will recognize that the foregoing description and examples have been presented for the purposes of illustration and example only. The description as set forth is not intended to be exhaustive or to limit the disclosure to the precise form disclosed.

In view of the foregoing, the scope of the present disclosure is determined by the claims that follow.

We claim:

1. An input device, comprising:
a plurality of sensor electrodes in a sensing region of the input device; and
a processing system coupled to the plurality of sensor electrodes, the processing system configured to:
evaluate capacitive sensing data to identify a current location of an input object along a single axis;
identify, using the current location, an entry in a data structure corresponding to the input object, wherein the data structure is configured to store multiple entries each corresponding to a different input object previously detected by the processing system; and
determine whether the input object has performed a predefined gesture by comparing the current location to a previous location of the input object on the single axis, wherein the previous location was stored in the identified entry.

2. The input device of claim 1, wherein determining whether the input object has performed the predefined gesture comprises:
determining at least one of (i) a distance between the current and previous locations, (ii) a direction of movement of the input object along the single axis based on the current and previous locations, and (iii) a velocity of the input object based on the current and previous locations.

3. The input device of claim 1, wherein a side of the sensing region defines the single axis, wherein the current location of the input device corresponds to an estimated physical location of the input device along the side of the sensing region when the input object is not above the sensing region.

4. The input device of claim 3, wherein determining whether the input object has performed the predefined gesture comprises:
determining whether the input object has tapped a side of the input device proximate to the side of the sensing region.

5. The input device of claim 4, wherein determining whether the input object has tapped a side of the input device proximate to the side of the sensing region comprises:
receiving different capacitive sensing data from a first capacitive frame different than the capacitive sensing data received during a second, subsequent capacitive frame;
determining that the input object has been lifted off from the side of the input device based on the different capacitive sensing data; and
determining that the current location of the input device substantially matches the previous location stored in the identified entry, wherein the previous location is the location of the input device prior to being lifted off.

6. The input device of claim 3, wherein determining whether the input object has performed the predefined gesture comprises:
determining whether the input object has swiped a side of the input device proximate to the side of the sensing region.

7. The input device of claim 1, wherein the processing system is configured to:
receive different capacitive sensing data from a first capacitive frame different than the capacitive sensing data received during a second capacitive frame, wherein the first capacitive frame is generated after the second capacitive frame,
determine that a first location represented by the different capacitive sensing data corresponds to the input object by matching the first location to the identified entry in the data structure, and
upon determining that the input object has performed a different predefined gesture based on the first location, determine that the predefined gesture and the different predefined gesture match a predefined combination gesture performed by the input object.

8. The input device of claim 7, wherein the predefined combination gesture indicates that the input object has twice tapped a side of the input device proximate to a side of the sensing region defining the single axis.

9. The input device of claim 7, wherein the processing system is configured to:
upon determining the input object has performed the predefined gesture, update a record indicating that the predefined gesture has been performed, wherein the processing system is configured to wait a period of time before reporting the predefined gesture to a host processor in the input device until determining whether the input object performed the combination gesture using the predefined gesture.

10. A processing system, comprising:
a first detection module configured to evaluate capacitive sensing data to identify a current location of an input object along a single axis, wherein the capacitive sensing data is measured using a plurality of sensor electrodes in a sensing region of an input device; and
a gesture detection module configured to:
identify, using the current location, an entry in a data structure corresponding to the input object, wherein the data structure is configured to store multiple entries each corresponding to a different input object previously detected by the processing system; and
determine whether the input object has performed a predefined gesture by comparing the current location to a previous location of the input object on the single axis, wherein the previous location was stored in the identified entry.

11. The processing system of claim 10, wherein determining whether the input object has performed the predefined gesture comprises:
determining at least one of (i) a distance between the current and previous locations, (ii) a direction of movement of the input object along the single axis based on the current and previous locations, and (iii) a velocity of the input object based on the current and previous locations.

12. The processing system of claim 10, wherein a side of the sensing region defines the single axis, wherein the current location of the input device corresponds to an estimated physical location of the input device along the side of the sensing region when the input object is not above the sensing region.

13. The processing system of claim 12, wherein determining whether the input object has performed the predefined gesture comprises:
determining whether the input object has tapped a side of the input device proximate to the side of the sensing region.

14. The processing system of claim 12, wherein determining whether the input object has performed the predefined gesture comprises:
determining whether the input object has swiped a side of the input device proximate to the side of the sensing region.

15. The processing system of claim 10, wherein the gesture detection module is configured to:
receive different capacitive sensing data from a first capacitive frame different than the capacitive sensing data received during a second capacitive frame, wherein the first capacitive frame is generated after the second capacitive frame; and
determine that a first location represented by the different capacitive sensing data corresponds to the input object by matching the first location to the identified entry in the data structure, and
wherein the processing system further comprises a combination gesture detection module configured to, upon determining that the input object has performed a different predefined gesture based on the first location, determine that the predefined gesture and the different predefined gesture match a predefined combination gesture performed by the input object.

16. A method, comprising:
measuring capacitive sensing data using a plurality of sensor electrodes in a sensing region of an input device;
evaluating the capacitive sensing data to identify a current location of an input object along a single axis;
identifying, using the current location, an entry in a data structure corresponding to the input object, wherein the data structure is configured to store multiple entries each corresponding to a different input object previously detected by a processing system; and
determining whether the input object has performed a predefined gesture by comparing the current location to a previous location of the input object on the single axis, wherein the previous location was stored in the identified entry.

17. The method of claim 16, wherein determining whether the input object has performed the predefined gesture comprises:
determining at least one of (i) a distance between the current and previous locations, (ii) a direction of movement of the input object along the single axis based on the current and previous locations, and (iii) a velocity of the input object based on the current and previous locations.

18. The method of claim 16, wherein a side of the sensing region defines the single axis, wherein the current location of the input device corresponds to an estimated physical location of the input device along the side of the sensing region when the input object is not above the sensing region.

19. The method of claim 18, wherein determining whether the input object has performed the predefined gesture comprises:
determining whether the input object has tapped a side of the input device proximate to the side of the sensing region.

20. The method of claim 19, wherein determining whether the input object has tapped a side of the input device proximate to the side of the sensing region comprises:
receiving different capacitive sensing data from a first capacitive frame different than the capacitive sensing data received during a second, subsequent capacitive frame;
determining that the input object has been lifted off from the side of the input device based on the different capacitive sensing data; and
determining that the current location of the input device substantially matches the previous location stored in the identified entry, wherein the previous location is the location of the input device prior to being lifted off.
